(19) United States
(12) Patent Application Publication
(10) Pub. No.: US 2018/0126337 A1
(43) Pub. Date: May 10, 2018

(54) Generalized Method for Producing Dual Transport Pathway Membranes

(71) Applicants: Christine M. Beavers, Pleasant Hill, CA (US); David K. Britt, El Cerrito, CA (US); Norman C. Su, Walnut Creek, CA (US); Daniel T. Sun, Sion (CH); Wendy L. Queen, Grimisuat (CH); Jeffrey J. Urban, Emeryville, CA (US)

(72) Inventors: Christine M. Beavers, Pleasant Hill, CA (US); David K. Britt, El Cerrito, CA (US); Norman C. Su, Walnut Creek, CA (US); Daniel T. Sun, Sion (CH); Wendy L. Queen, Grimisuat (CH); Jeffrey J. Urban, Emeryville, CA (US)

(73) Assignee: The Regents of the University of California, Oakland, CA (US)

(21) Appl. No.: 15/803,425

(22) Filed: Nov. 3, 2017

Related U.S. Application Data
(60) Provisional application No. 62/417,954, filed on Nov. 4, 2016.

(51) Int. Cl. B01D 67/00; B01D 69/14; B01D 53/22

(52) U.S. Cl. CPC B01D 67/0079; B01D 71/028; B01D 53/228; B01D 69/148

(57) ABSTRACT

A hybrid polymer/inorganic membrane with dual transport pathways overcomes traditional limitations. The inorganic phase consists of a metal-organic framework (MOF), which is an ideal inorganic dispersant to construct dual transport pathways as the crystalline porous structure of MOFs is more amenable to molecular diffusion than polymers. Previous hybrid membrane research has failed to achieve sufficiently high loadings to establish a percolative network necessary for dual transport, often due to mechanical failure of the membrane at high loading. Using polysulfone and UiO-66-NH₂ MOF as a model system, we achieve high MOF loadings (50 wt %) and observe the evolution from single mode to dual transport regimes. The newly formed percolative pathway through the MOF acts as a molecular highway for gases. As the MOF loading increases to 30 wt %, CO₂ permeability increases linearly from 5.6 barrers in polysulfone homopolymer to 18 barrers. Crucially, between 30 and 40 wt %, a percolative MOF network arises and the CO₂ permeability dramatically rises from 18 to 46 barrers; an eight-fold increase over pure polysulfone, while maintaining selectivity over methane and nitrogen near the pure polymer at 24 and 26, respectively.

### CROSS REFERENCE TO RELATED APPLICATIONS

This US application claims priority to U.S. Provisional Application Ser. No. 62/417,954 filed Nov. 4, 2016, which application is incorporated herein by reference as if fully set forth in their entirety.

### STATEMENT OF GOVERNMENTAL SUPPORT

The invention described and claimed herein was made in part utilizing funds supplied by Grant Number FA9550-11-C-0028, Department of Defense, National Defense Science & Engineering Graduate (NDSEG) Fellowship, and the U.S. Department of Energy under Contract No. DE-AC02-05CH11231 between the U.S. Department of Energy and the Regents of the University of California for the management and operation of the Lawrence Berkeley National Laboratory. The government has certain rights in this invention.

### BACKGROUND OF THE INVENTION

### Field of the Invention

The present invention relates to the field of membranes.

### Related Art

Membranes are an emerging technology to replace conventional gas separation and purification strategies utilizing absorption or adsorption based processes due to lower energy requirements, less capital cost, and lower physical footprints. Our initial focus has been towards carbon capture applications, but membranes are widely considered to be important technologies in olefin/paraffin separation, nitrogen/oxygen purification, natural gas processing, hydrogen separation to name a few. However, in order for membranes to become performance competitive with adsorption/absorption based processes, membrane permeability and to some extent selectivity need to be greatly improved. Hybrid membranes can achieve this performance enhancement by harvesting gas selective properties of many inorganic materials. Our work focused on developing new materials systems to understand the role of polymer/inorganic interactions on performance enhancements or losses.

We have developed a novel hybrid material system to achieve high permeability for gas separations relevant for carbon capture. MOF presents an additional transport mechanism if used in hybrid membranes because of their rigid porous crystal structure. Our goal was to investigate performance improvements of hybrid membranes when MOF are used.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 illustrates X-ray diffraction pattern of synthesized UiO-66-NH₂ matches well with simulated pattern. FIG. 1 also illustrates Nitrogen adsorption isotherm of UiO-66-NH₂ powder at 77 K.

FIG. 2 illustrates higher magnification SEM cross-section images.

FIG. 3 illustrates lower magnification SEM cross-section images.

FIG. 4 illustrates X-ray diffraction patterns of UiO-66-NH₂ and hybrid membranes containing 0 to 50 wt % UiO-66-NH₂. Maximum peak intensities of hybrid membranes correlate well with MOF loading after normalization with membrane thickness.

FIG. 5 illustrates CO₂ adsorption isotherms of UiO-66-NH₂ and UiO-66-NH₂ containing membranes at 25° C. Total CO₂ adsorption of membranes containing UiO-66-NH₂ scale with MOF loading.

FIG. 6 illustrates pure gas permeabilities of CO₂ (triangles), N₂ (squares), and CH₄ (circles) at 3 bar and 35° C. of hybrid UiO-66-NH₂ polysulfone membranes as a function of weight % of the MOF. There is a dramatic jump in permeability between 30 and 40 wt % due to percolative network of MOF crystals. Error bars represent a single standard deviation.

FIG. 7 illustrates ideal CO₂/N₂ (squares) and CO₂/CH₄ (circles) selectivities obtained from the hybrid UiO-66-NH₂ polysulfone membranes at 3 bar and 35° C. as a function of weight % of the MOF. Selectivity effectively remains constant with addition of UiO-66-NH₂. Error bars represent a single standard deviation.

FIG. 8 illustrates diffusion coefficients of CO₂ (triangles), N₂ (squares), and CH₄ (circles) at 3 bar and 35° C. as a function of UiO-66-NH₂ loading in hybrid membranes. Diffusion coefficient jumps between 30 and 40 wt % MOF due to the formation of interconnected MOF crystal network.

FIG. 9 illustrates solubility coefficients of CO₂ (triangles), N₂ (squares), and CH₄ (circles) at 3 bar and 35° C. as a function of UiO-66-NH₂ loading in hybrid membranes. Solubility shows a linear relationship with weight %. The dotted lines are linear regression fits of the data.

FIG. 10 illustrates hydrostatic density measurement of UiO-66-NH₂ PSF hybrid membranes. Density follows a linear trend, indicating good interphase interaction.

FIG. 11 illustrates FT-IR spectra of UiO-66-NH₂, PSF, and 30 wt % UiO-66-NH₂/PSF, primary amine peak of UiO-66-NH₂ at 1567 cm⁻¹ becomes less apparent upon incorporation with PSF at 30 wt % indicating possible hydrogen interactions, sulfonyl peak at 1150 and 1170 cm⁻¹ does not shift with addition of UiO-66-NH₂

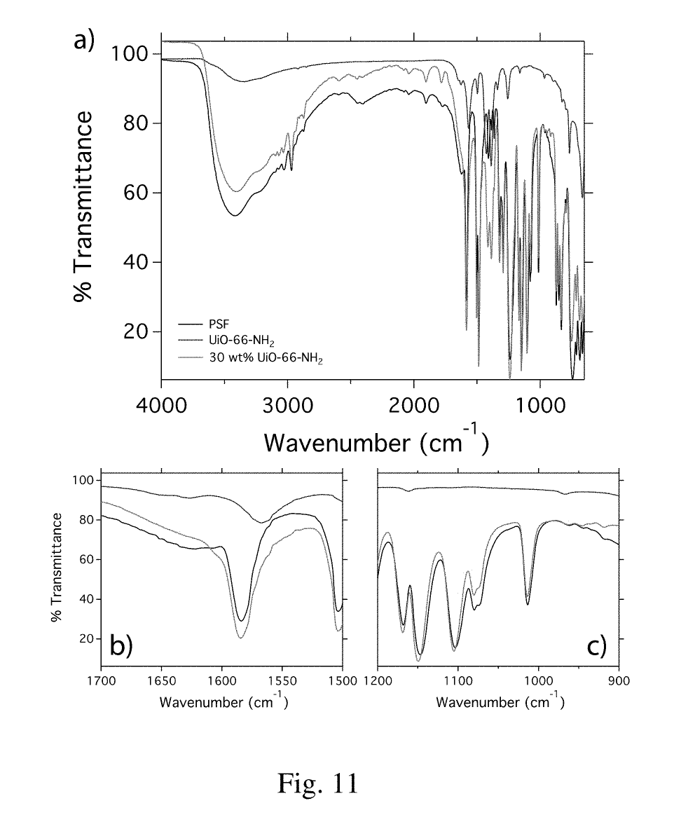

FIG. 12 illustrates comparing Maxwell's predicted permeability with a spherical shape factor of n=⅓ and P_{d}=∞ to experimental permeability. Maxwell's permeability consistently underestimates permeability for CO₂, N₂, and CH₄; this breakdown in the predictive value of the model is accentuated for high MOF loadings

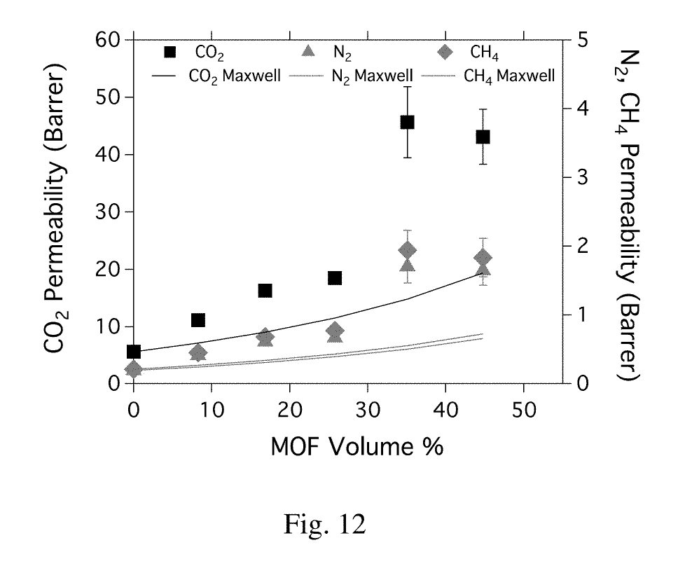

FIG. 13 illustrates comparing Maxwell's permeability with an adjustable shape factor. n converges to 0.14. Permeability of UiO-66-NH₂ ranges from 500-1000 barrers. Maxwell permeability trends shown for 580 and 950 barrer. Excellent correlation with experimental permeability below 30 wt %.

FIG. 14 illustrates SEM image of UiO-66-NH₂ nanoparticles. We observe partial aggregation of smaller domains of UiO-66-NH₂, which results in presence of elongated UiO-66-NH₂ ellipsoids (inset) consistent with percolation theory.

FIG. 15 illustrates DSC thermograms of UiO-66-NH₂ PSF hybrid membranes. Scan rate 20° C./min. T_{g} increases with increasing MOF loading.

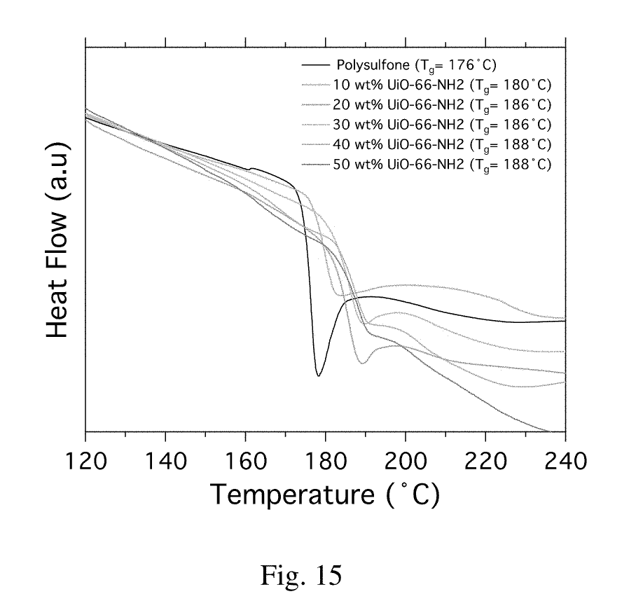

FIG. 16 illustrates schematic of formation of percolative interconnected network of MOF crystals with ellipsoid geometry. Interconnected network of MOF crystals is formed when percolation threshold is reached.

FIG. 17 illustrates a Robeson upper bound plot of UiO-66-NH₂ PSF hybrid membranes for CO₂/N₂ and CO₂/CH₄. In both cases, the addition of MOF moves the transport performance of the hybrid membrane closer to the upper bound line.

FIG. 18 illustrates CO₂ activation energy for diffusion, E_{D} as a function of MOF weight %. Under the percolation threshold (up to 30 wt % MOF), the activation energy shows no significant decrease. Over the percolation threshold (over 40 wt % MOF), E_{D} drops significantly due to the formation of dual transport pathways.

### DETAILED DESCRIPTION

In the discussions that follow, various process steps may or may not be described using certain types of manufacturing equipment, along with certain process parameters. It is to be appreciated that other types of equipment can be used, with different process parameters employed, and that some of the steps may be performed in other manufacturing equipment without departing from the scope of this invention. Furthermore, different process parameters or manufacturing equipment could be substituted for those described herein without departing from the scope of the invention.

These and other details and advantages of the present invention will become more fully apparent from the following description taken in conjunction with the accompanying drawings.

Our invention addresses the need for higher performing membranes to compete more effectively with absorption/adsorption based gas separation processes.

One alternative method is through use of polymer engineering. By increasing the rigidity and complexity of the polymer backbone through complex synthetic steps, one is able to greatly increase the free volume in the polymer and improve the permeability. However, because polymers are in constant fluid motion, the polymer begins to relax and the free volume can significantly decrease, leading to large loss in performance, within a few days. Our membranes show performance stability after 300 days. A second alternative incorporates a liquid agent in the membrane to help facilitate the transport of gas across the membrane. However, the volatility of the liquid leads to a decrease in performances as the liquid evaporates.

The invention is most immediately translatable to many gas separation industries including but not limited to carbon capture, olefin/paraffin separation, oxygen/nitrogen purification, natural gas processing, and hydrogen separation. This invention of dual transport pathways can also be applied to development of better reverse osmosis and forward osmosis membranes as well as increasing ionic and electronic conductivity of electrolyte membranes and battery separators is appropriate materials are chosen. The invention can be licensed to further the performance of dual transport membranes.

We describe a novel method to develop a high-performing hybrid polymer/inorganic membrane possessing dual transport pathways, which has never been reported before. The presence of dual transport pathways significantly improves the performance of polymer-based membranes. Our current invention shows an 800% increase in performance over the base-polymer used.

Conventional purely polymer or inorganic membranes suffer from permeability/selectivity trade-off or mechanical brittleness, thereby limiting their ultimate performance. By forming a hybrid material system, wherein an inorganic nanomaterials is dispersed in a polymer matrix, we can enhance the gas separation performance over the base polymer system by harvesting the gas selective properties of the inorganic component, metal-organic frameworks (MOFs). The superior performance of these hybrid membranes, is only realized upon surpassing a critical concentration of the MOF, and is an important foundation for this invention.

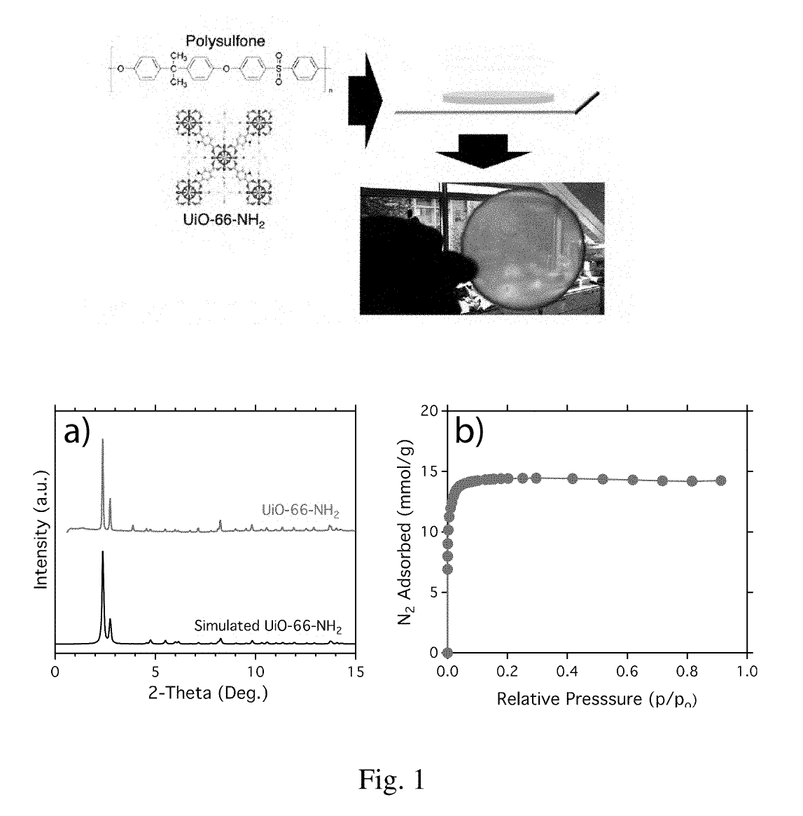

In conventional hybrid systems, membranes are not mechanically stable at high MOF concentrations (>30 wt %), and as a result, cannot perform under stresses required for membrane gas separation. Taking advantage of positive interactions between the polymer, polysulfone, and the MOF, UiO-66-NH2, we create a novel material system where high concentrations of MOF can be achieved (50 wt %) while still maintaining mechanical stability. This was the biggest technical challenge to overcome because mechanical properties are weakened when MOF concentration increases and the membrane becomes more brittle. We overcome this challenge through appropriate selection of both the polymer and the MOF, which interact favorable with each other. The fabrication of the MOF is done using solvent casting approaches (see FIG. 1), but can be translated to doctor blading and other thin film coating techniques.

Membranes with MOF concentrations at or below 30 wt % have limited performance because the overall gas separation properties are governed by the polymer and solution-diffusion principles. Upon exceeding a percolation threshold (determined by the concentration and shape factor of the MOF, e.g. ellipsoid with an aspect ratio of 2 has critical percolation concentration of 31 vol %), a continuous channel through the MOF exists across the membrane. This continuous channel serves as a secondary, but more efficient, transport pathway across the membrane allowing gas molecules to entirely bypass contact with the polymer. The secondary MOF pathway enables significantly higher rates of permeation because the rigid pore structure enables separation through molecular sieving rather than solution diffusion.

The example materials system polysulfone/UiO-66-NH2 exhibit an 800% increase in permeability over pure polysulfone once the critical percolation threshold was surpassed. Without the presence of the secondary pathway the maximum improvement in permeability observed was only 280%. The permeability improvement in the hybrid system, combined with maintaining selectivity of the pure polymers, shows the possibility to break permeability/selectivity trade-offs of conventional polymer membranes. The method of utilizing a hybrid system to enable performance enhancements is a more fruitful pathway over polymer engineering strategies because it does not depend on complex synthetic reaction steps to achieve the necessary material properties desired. The general concept of producing dual transport pathways in membranes can be applied across many applications to improve gas separation, water purification and electrical conductivity performances.

### Broader Context

Membranes have been targeted as an energy-efficient method to improve carbon capture technology because of their passive and continuous nature of operation (i.e. no regeneration steps needed). However, current commercialized membranes do not meet the performance standards to replace traditional pressure- and temperature-swing adsorption processes. Hybrid membranes composed of organic and inorganic materials offer new opportunities to achieve higher performance metrics due to performance advantages unique to each phase. However, while hybrid membranes display transport properties higher than their pure counterparts, there remains much headspace to further improve the separation efficiency.

In conventional mixed matrix systems, the inorganic phase often cannot be incorporated in sufficient quantity to establish a percolative network. Thus, their transport behavior can be easily understood using simple effective-medium approximations and is constrained by conventional solution-diffusion principles. If instead, the inorganic phase can exist continuously across the membrane, there is an opportunity to reach new non-classical transport regimes governed by dual transport pathways. Here, we demonstrate, for the first time, the ability to engineer dual transport pathways in polysulfone and UiO-66-NH₂ MOF hybrid membranes by achieving very high loadings of MOF (50 wt %), which result in an 8-fold improvement in CO₂ permeability from the pure polymer. These results enable new approaches towards designing hybrid membranes to become more competitive in carbon capture processes.

### Introduction

While historical trends indicate the gradual decarbonization of fuel sources over time, the global economy in its present state remains heavily dependent on fuels with high carbon content such as coal, oil, and natural gas. Consequently, carbon emissions are reaching record levels and are identified as contributing to recent patterns of global climate change. Mitigating carbon emissions to reverse or curb climate change using traditional amine scrubbing techniques is not scalable due to the large energy consumption and physical footprint required. Membrane separation processes have emerged as a promising technology because of the passive nature of its operation and relative ease of scalability. Unfortunately, many commercialized membranes have not been optimized for the stringent purification metrics required for carbon capture applications. These membranes, typically derived from polymers, suffer from an inherent trade-off between permeability and selectivity as popularized by Robeson and his eponymous plot. The central dilemma is that many polymers provide either high permeability or high selectivity but not both, which limits the industrial utility of these systems.

Hybrid membranes, which typically contain an organic polymer phase and a dispersed inorganic phase, have been shown to significantly improve separation performance over pure polymer systems in a variety of applications including carbon capture, hydrogen purification, and petrochemicals. The inorganic phase can be a nonporous materials such as nanoparticles or porous materials such as carbon molecular sieves, zeolites, and metal-organic frameworks. When integrated with an organic polymer into a hybrid system, the competitive advantages of each individual phase can be realized, such as the processibility of polymers and molecular selectivity of inorganics, while also fostering new properties and functionalities through synergistic enhancements.

While conventional mixed matrix systems display improved separation properties, the inorganic phase often is not present in sufficient quantity to establish a percolative network, and thus their transport behavior is limited by classical solution-diffusion principles. If hybrid membranes can be designed to possess continuity of both organic and inorganic phases, there is an opportunity to reach new non-classical transport regimes governed by dual transport pathways. In this dual transport regime, the inorganic phase will act as a molecular transport highway. However, achieving dual transport pathways is no easy feat as high loadings of the inorganic phase are required to achieve percolation.

Only a few studies have reported inorganic loadings in hybrid membranes surpassing 40 wt % due to mechanical failure of the membrane. This is primarily a result of poor interphase interactions, which lead to the formation of voids, commonly referred to as “sieves-in-a-cage,” in hybrids containing porous inorganic materials. Under these circumstances, molecular diffusion can circumvent the inorganic sieve and instead transport through the less selective voids at the interface. Thus, precise control of both the polymer and inorganic phase is critical to maximize separation performance.

Metal-organic frameworks (MOFs) are a relatively new class of 3-D porous crystalline inorganic materials that are ideal candidates to incorporate in hybrid membranes and design dual transport pathways. Their chemical flexibility provides opportunities to tune and optimize interfacial interactions between the MOF crystal and a polymer, thus reducing chances for mechanical failure. Further, large internal surface areas, tunable but rigid pores, and chemical functionalities of MOFs (accessible through functionalization of the organic linkers or Lewis acid open metal site) can simultaneous improve diffusive size selectivity and adsorption uptake of gases in membranes. While inclusion of the MOF as a dispersed phase can be expected to improve gas transport properties, the full benefit of hybrid MOF membranes is only realized when a continuous phase exists, which would lead to a percolative transport highway.

Here, we report on the design and characterization of robust hybrid membranes possessing dual transport pathways using UiO-66-NH₂ MOF and polysulfone for relevant carbon capture applications. UiO-66-NH₂ is a zirconium based MOF, comprised of Zr₆O₄(OH)₄ octahedral clusters and 2-amino-1,4 benzenedicarboxalate linkers. UiO-66-NH₂ is a well-studied MOF and exhibits high thermal stability, water stability, and carbon dioxide adsorption. We selected the amine derivative over its non-functionalized counterpart (UiO-66) to maximize interactions with polar backbone groups in the polysulfone polymer, which is critical to avoid mechanical failure as we increase the MOF loading beyond what is normally considered high loadings (i.e. 30 wt %). This hybrid system successfully maintains structural integrity at very high loadings. We demonstrate, to the best of our knowledge, the first hybrid system possessing dual transport pathways.

### Experimental Section

### UiO-66-NH₂ Synthesis

UiO-66-NH₂ is prepared following a modified version of a microwave synthetic technique. Zirconium tetrachloride (99.5%) is supplied by Alfa Aesar, 2-amino-1,4-benzenedicarboxylic acid (99%) and dimethylformamide (99%) is supplied by Sigma-Aldrich.

35 mmol of ZrCl₄ (8.12 g) and 0.11 mmol of nanopure water (2 ml) are added to 148 mmol (400 mL) of DMF.

The solid is allowed to fully dissolve. Separately, 35 mmol (6.28 g) of 2-aminoterephthalic acid is dissolved in 148 mmol DMF.

The solutions are combined and heated using microwave irradiation (Anton Paar) in sealed vessels at 1500 W for two hours at 120° C.

The resulting pale yellow powder is filtered and washed with methanol in a Soxhlet extractor overnight. The final product is dried in air overnight and finally in an oven at 65° C. to remove residual solvent.

### Fabrication of Membranes

Udel P-1700 polysulfone is generously supplied by Solvay Plastics. Polysulfone (PSF) is dried overnight in a vacuum oven at 110° C. prior to use. PSF is dissolved in chloroform (BDH Chemicals) to form a 5 wt % solution and subsequently filtered with a 0.45 μm PVDF filter. For hybrid membranes containing up to 50 wt % UiO-66-NH₂, the MOF is first dispersed in chloroform by sonication. Once dispersed, the MOF is “primed” by adding a portion of the PSF solution equal to 35 wt % of the total MOF mass and subsequently sonicated. Priming the MOF is believed to increase interaction and homogeneity between the MOF and polymer by coating the MOF with a thin polymer layer. The remaining PSF is then added to the MOF mixture and sonicated. To mitigate MOF settling during casting, the solution is concentrated by gentle purging with nitrogen gas to evaporate the solvent until the solids concentration reaches 25-30 wt %. The solution is then cast into a casting plate, loosely covered, and allowed to dry under atmospheric conditions over the course of two days. The dried membranes are then placed into a vacuum oven at 110° C. overnight to remove any residual solvent and water. The target thickness of each film is 65 μm. The thickness of each film is measured individually using a micrometer.

### MOF and Membrane Characterization

Nitrogen adsorption measurements of the MOF are performed at 77 K using a Tristar II Surface Area Analyzer (Micromeritics). Surface area values are calculated following Brunauer-Emmett-Teller method over a relative pressure range, p/pₒ, of 0.05 to 0.25. Carbon dioxide adsorption isotherms of the MOF and membranes are collected using an ASAP 2020 Physisorption Analyzer (Micromeritics) at 20° C. up to a pressure of 1 bar. Before adsorption measurements are carried out, all samples are heated under vacuum at 110° C. for 12 hours to remove residual solvent in the pores.

X-ray diffraction patterns of the MOF powder and hybrid membranes are collected at ALS Beamline 12.2.2 on a Perkin Elmer amorphous silicon detector using synchrotron radiation monochromated by silicon(111) to a wavelength of 0.4978(1) Å. Distance and wavelength calibrations were done, using a NIST LaB₆ diffraction standard, with the program Dioptas, which was also employed for radial integration. Simulated powder diffraction patterns of UiO-66-NH₂ are calculated using Mercury 3.6 software (Cambridge Crystallographic Data Centre). Glass transition temperatures of the membranes are determined using a Q200 Differential Scanning calorimeter (TA Instruments). The samples are heated under vacuum at 110° C. for two hours to remove water vapor before scanning to 250° C. at a scan rate of 20° C./min. Density measurements of the bulk hybrid films are performed using hydrostatic weighing with a density determination kit (Mettler Toledo). Heptane is used as the secondary liquid. Cross-sectional images of the hybrid films are acquired with a Zeiss Gemini Ultra-55 Analytical Scanning Electron Microscope using an accelerating voltage of 5 keV. Prior to imaging, the films are cryofractured after immersion in liquid N₂ to provide a clean surface.

### Gas Transport Measurements

Pure gas permeability of PSF/UiO-66-NH₂ membranes for nitrogen, methane, and carbon dioxide are measured using a custom built constant volume/variable pressure apparatus. The films are masked with brass discs to accurately define an area through which gas transport could occur. Prior to testing, the films are degassed within the apparatus. A fixed pressure is applied to the upstream side of the membrane, while the gas flux is recorded as a steady-state pressure rise downstream of the membrane. Permeability values are calculated as follows:

$$P = \frac{{V}_{D} l}{{p}_{2} A R T} ( \frac{{dp}_{1}}{dt} ) \qquad 2 )$$

where V_{D} is the downstream volume (cm³), 1 is the film thickness (cm), p₂ is the upstream pressure (cmHg), A is the exposed area of the film (cm²), R is the gas constant, T is the absolute temperature (K), and dp₁/dt steady state pressure rise downstream at fixed upstream pressure (cmHg/sec). The measurements are obtained under isothermal conditions at 308 K.

Diffusivity and solubility of the hybrid membranes are calculated through permeation time lag experiments described in detail elsewhere and analyzed employing the solution-diffusion model.

### Results and Discussions

### Characterization of UiO-66

Traditional MOF synthesis relies on conventional solvothermal techniques, which usually requires prolonged reaction times that range from hours to several days. Microwave assisted synthetic techniques are an emerging method to rapidly synthesize MOFs and other microporous materials within a matter of minutes to a few hours without compromising crystallite quality. This technique is not only advantageous for its short reaction time, but also for its scalability and particle size control. We employ microwave synthesis for UiO-66-NH₂ for the reasons listed above and to minimize the risk of batch-to-batch variation. All hybrid membranes investigated contained MOFs from a single large-scale batch. In FIG. 1a, the powder X-ray diffraction pattern of the synthesized UiO-66-NH₂ shows excellent agreement with the simulated diffraction pattern. Nitrogen adsorption isotherms were collected at 77 K, as shown in FIG. 1b, and follow Type 1 isotherm indicative of microporosity. Based upon this analysis, the BET surface area is calculated to be 1348±5 m²/g, which is higher than previously reported surface area values for UiO-66-NH₂, which fall between 1000 and 1150 m²/g.

### Hybrid Membrane Characterization

By controlling the MOF-polymer interface using the techniques described previously, robust polysulfone membranes containing up to 50 wt % UiO-66-NH₂ are successfully fabricated. Few MOF-polymer membranes at such high loadings have been reported; mainly a result of mechanical failure of the membrane at these loadings, due to poor interphase interactions. Thus, when undertaking the design of hybrid membranes, it is imperative to select materials which are not only individually good materials for CO₂ capture, but also with mutual chemical affinities to maximize interphase adhesion and solubility and minimize the onset of sieve-in-a-cage morphology, which deleteriously impacts the gas selectivity. One diagnostic used to understand the magnitude and type of interfacial interactions in hybrid soft/hard systems are shifts in the glass transition temperature (T_{g}). Favorable interactions are noted by a T_{g} shift towards higher temperatures. This positive shift is due to reduced polymer chain mobility and rigidification as the polymer becomes adsorbed onto the MOF surface, resulting in a more mechanically robust membrane. Opposite trends (i.e. reductions in T_{g} relative to that of the homopolymer) are observed when unfavorable interactions are present. Glass transition temperatures as measured by differential scanning calorimetry of the hybrid membranes are presented in Table 1. The T_{g} of the neat homopolymer is 176° C. The incorporation of 10 wt % UiO-66-NH₂ has a minor influence on the T_{g}, shifting it by only 4° C. As MOF is further added to the membrane, we observe a larger T_{g} shift of 10-12° C. to a maximum T_{g} of 188° C. The T_{g} shifts at all loadings indicates that favorable interactions are present, and we speculate this is due to hydrogen bonding interactions between the amine groups of the MOF and sulfonyl groups in the polymer. The interactions are sufficiently strong that any post-synthetic surface modification of the MOF to promote interaction is not required.

TABLE 1
Glass Transition Temperature of Hybrid Membranes

| UiO-66-NH₂ weight % | T_{g} (° C.) |
|---|---|
| 0 | 176 |
| 10 | 180 |
| 20 | 186 |
| 30 | 186 |
| 40 | 188 |
| 50 | 188 |

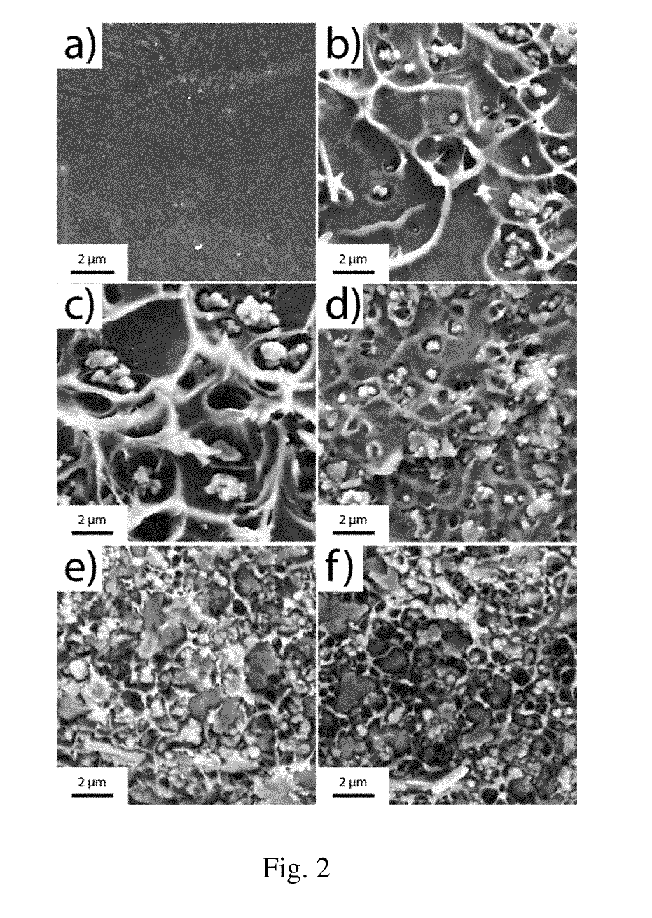

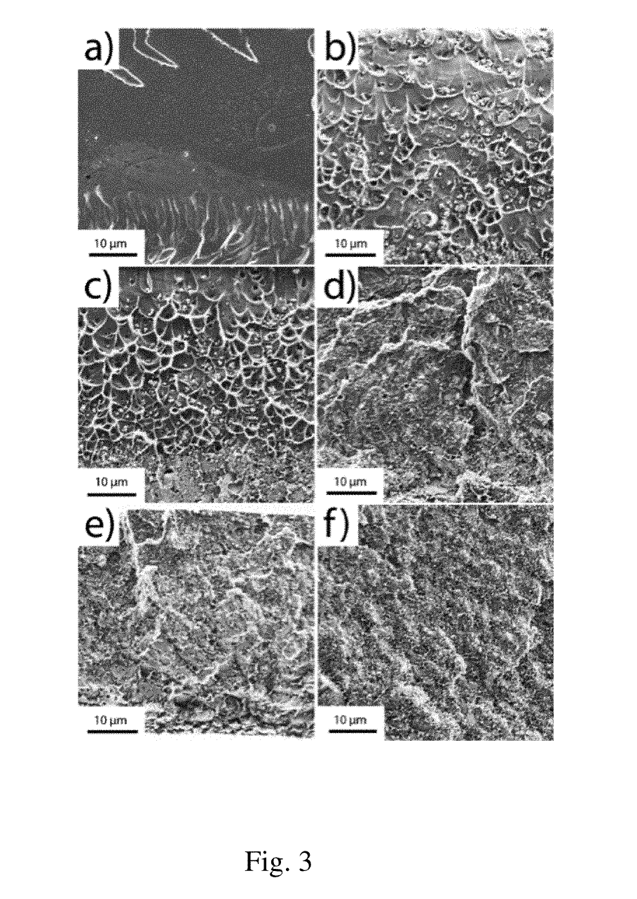

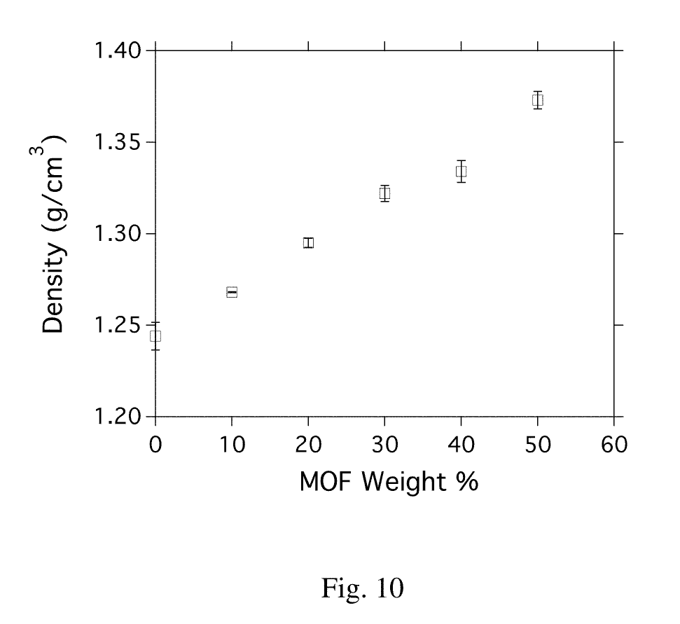

Physical confirmation of good interfacial interactions as indicated by the aforementioned T_{g} shifts can be seen through cross-sectional imaging of the hybrid membranes. SEM cross-sections of the membranes are shown in FIG. 2 and FIG. 3 at higher and lower magnifications, respectively. The PSF homopolymer is highly uniform and dense with no sign of pinhole defects (FIGS. 2a and 3a). Strong interfacial interactions are observed in membranes containing 10 wt % UiO-66-NH₂ (FIGS. 2 and 3) as indicated by the homogenous distribution of MOF crystals throughout the polymer. At this loading, there is minimal aggregation between MOF crystals, which have a crystallite size of approximately 400 nm in diameter. As MOF loading is increased up to 50 wt %, the membranes still display homogeneity between the polymer and MOF. Above 50 wt %, the hybrid membrane begins to lose mechanical stability. Thus, higher membrane loadings were not pursued. Furthermore, the appearance of a network of circular pattern morphology of the polymer is additional evidence of the presence of strong interfacial interactions. The addition of UiO-66 induces shear stress of the polymer, which results in rigidifactions and elongation of polymer chains. As UiO-66-NH₂ is incorporated with the polymer, the interaction between the two phases induces a rigidification and elongation of polymer chains. This phenomenon is more evident in hybrids containing 10 and 20 wt % UiO-66-NH₂. This morphology is not to be confused with sieve-in-a-cage where delamination between the phases creates a significant volume fraction of interphase voids. As further confirmation that sieve-in-a-cage was not present in our hybrid membranes, we calculated the bulk density of each membrane as shown in FIG. 10 of the electronic supplementary information (ESI). If significant voids were present in the membranes, they would manifest itself as a non-linear density trend where the true density of the films is lower than the arithmetic average between the two phases. Our hybrid membranes show a clear linear relationship between density and weight % further suggesting that good interfacial contact is present.

In addition to detecting strong interfacial interactions, the SEM cross-sections reveal another significant characteristic of these hybrid membranes advantageous for gas transport. At MOF loadings of 30 wt % or below, the MOF can be clearly discerned from the polymer as seen in FIG. 3. At these loadings, there is sufficient polymer to completely enwrap MOF crystals. However, at 40 wt % and above, it becomes much more difficult to observe isolated MOF and polymer regions. The SEM images in FIGS. 2e and 2f appear to show an interconnected network of MOF crystals occasionally interrupted by the polymer. We anticipate that the transport properties in 40 and 50 wt % hybrid membranes to be different than the other membranes investigated in this study because the interconnectivity of MOF crystals will provide a parallel transport pathway to the solution-diffusion mechanism for dense polymer membranes.

FIG. 2. Higher magnification SEM cross-section images of (a) polysulfone homopolymer and (b-f) hybrid membranes containing (b) 10 wt %, (c) 20 wt %, (d) 30 wt %, (e) 40 wt %, and (f) 50 wt % UiO-66-NH₂, respectively. The network polymer region (brighter regions) signifies good interfacial contact between the MOF and polysulfone.

FIG. 3. Lower magnification SEM cross-section images of (a) polysulfone homopolymer and (b-f) hybrid membranes containing (b) 10 wt %, (c) 20 wt %, (d) 30 wt %, (e) 40 wt %, and (f) 50 wt % UiO-66-NH₂, respectively. A shift in dispersion of MOF in membranes containing between 30 and 40 wt % MOF occurs, wherein interconnected MOF network can be seen in membranes containing more than 40 wt % MOF.

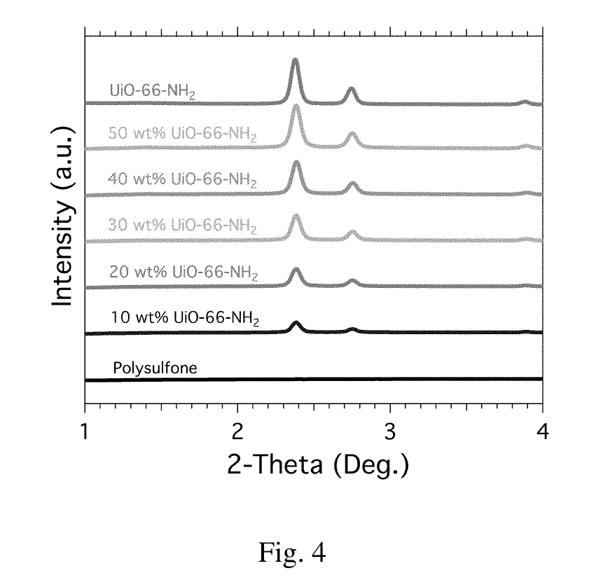

Transmittance X-ray diffraction was used to determine the presence of UiO-66-NH₂ in hybrid membranes and the diffraction patterns are shown in FIG. 4. The pure polysulfone membrane shows no diffraction peaks as expected because of its amorphous nature. All hybrid membranes containing UiO-66-NH₂ display at least the two primary diffraction peaks at 20 values of 2.38° and 2.68°, confirming that UiO-66-NH₂ maintains its crystallinity during membrane fabrication. Furthermore, if the intensities are normalized by membrane thickness, we find that the intensity of the highest peak correlates well with MOF loading. The hybrid membrane containing 10 wt % UiO-66-NH₂ has a maximum peak intensity of ˜25% of the maximum peak intensity of the membrane with a loading of 50 wt %. Following this trend the maximum peak intensity of 20, 30 and 40 wt % membranes are 44%, 59%, and 74% of the maximum peak intensity for 50 wt % membranes, respectively.

FIG. 4. X-ray diffraction patterns of UiO-66-NH₂ and hybrid membranes containing 0 to 50 wt % UiO-66-NH₂. Maximum peak intensities of hybrid membranes correlate well with MOF loading after normalization with membrane thickness.

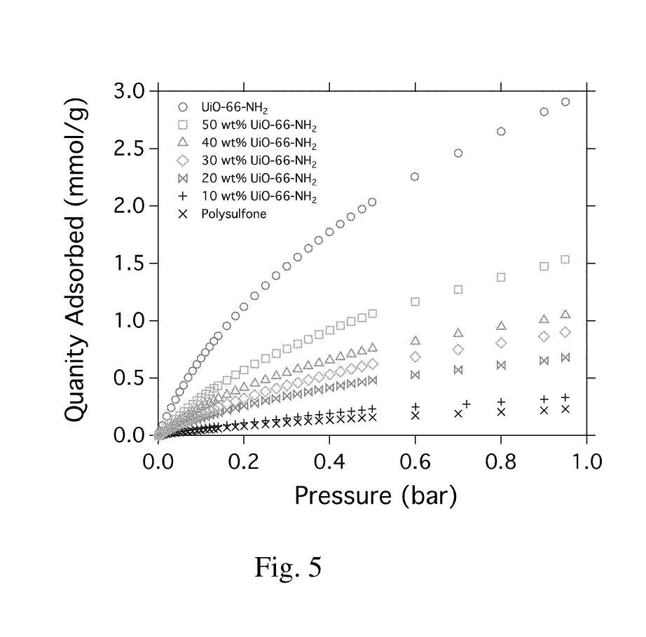

CO₂ adsorption isotherms of the hybrid membranes are collected at 25° C. as shown in FIG. 5. UiO-66-NH₂ powder exhibits a measured CO₂ adsorption of 2.91 mmol/g at 1 bar and matches well with literature. Similar to the XRD patterns, the total CO₂ adsorption correlates well with the MOF loading in the membranes. 50 wt % UiO-66-NH₂ membranes exhibit a CO₂ adsorption equivalent to 53% of the total CO₂ adsorption of just UiO-66-NH₂. Hybrid membranes containing 10, 20, 30, and 40 wt % UiO-66-NH₂ have CO₂ adsorption uptakes, which are 11%, 23%, 31%, and 37% of UiO-66-NH₂ only, respectively. The consistency of CO₂ uptakes with weight loading in these hybrid membranes is evidence of no pore blockage due to polymer chains. Pore blockage of porous materials by polymer chains is a major concern in hybrid membranes because it is known to be detrimental to the gas transport. Depending on the pore size, polymer chains can completely or partially infiltrate the pores of the MOF. Instead of gas molecules diffusing through the MOF, molecules would be forced to travel around the pore-blocked MOF, thereby increasing tortuosity and decreasing diffusion and permeability. As a result, we do not anticipate that pore blockage is detrimentally affecting the gas transport performance of the hybrid membranes.

FIG. 5. CO₂ adsorption isotherms of UiO-66-NH₂ and UiO-66-NH₂ containing membranes at 25° C. Total CO₂ adsorption of membranes containing UiO-66-NH₂ scale with MOF loading.

### Gas Transport Properties

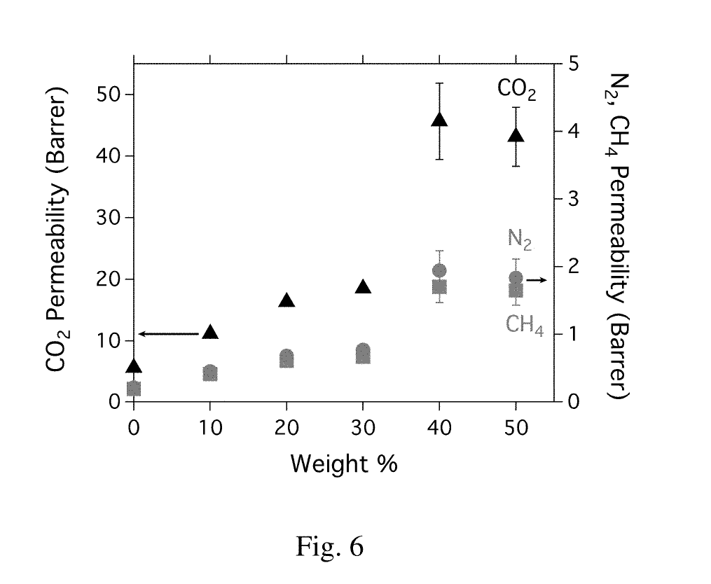

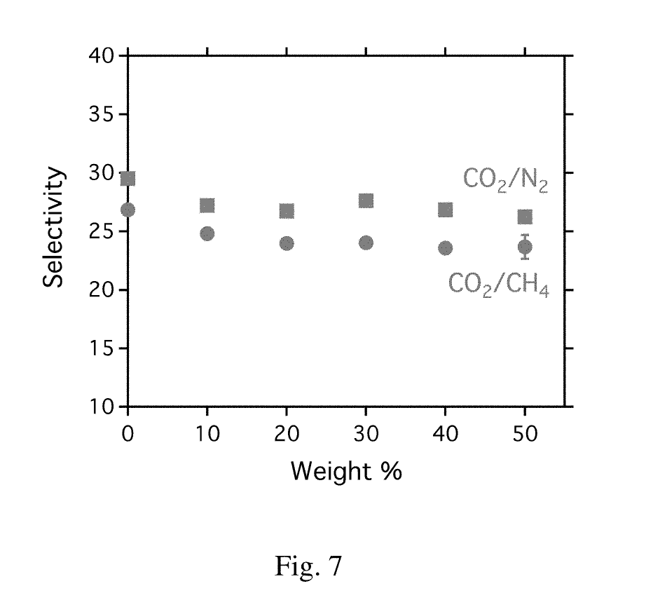

Pure gas permeability and selectivity of N₂, CH₄, and CO₂ at 35° C. and 3 bar are shown in FIGS. 6 and 7, respectively, as a function of weight % of UiO-66-NH₂. All hybrid membranes exhibited at least 200% higher permeability than the permeability of neat polysulfone membranes. Surprisingly, we observe a significant increase in permeability from hybrid membranes containing 30 wt % to 40 wt % MOF. At 30 wt %, the CO₂ permeability is 18 barrer or 3.3 times higher than polysulfone only. However, at 40 wt %, the CO₂ permeability dramatically leaps to 46 barrer or 8.1 times higher than neat polysulfone. The leap in permeability is not consistent with the linear behavior between 0 and 30 wt %, in which CO₂ permeability gradually increases from 5.6 to 18 barrers.

In order to understand the permeability trends in the hybrid MOF membranes, we perform analysis using a simple effective medium model. Such models often capture the physical behavior of a broad range of systems with a continuous phase and a dispersant. Specifically, permeability in heterogeneous two-phase materials are frequently modeled by Maxwell's model (Eqn. 1),

$${P}_{Maxwell} = {P}_{p} \frac{{nP}_{d} + ( 1 - n ) {P}_{p} - ( 1 - n ) {φ}_{d} ( {P}_{p} - {P}_{d} )}{{nP}_{d} + ( 1 - n ) {P}_{p} + n {φ}_{d} ( {P}_{p} - {P}_{d} )} \qquad ( 1 )$$

which consider the volume loading of the dispersed phase (i.e. MOF), ϕ_{d}, and the geometry shape factor of the dispersed phase, n, as the only adjustable parameters. P_{Maxwell}, Pₚ, and P_{d} are the permeability of the hybrid membrane, polymer, and dispersed phase, respectively. While the simplicity of the model allows for quick comparison of experimental data to the predicted values, the model does not consider the effects of interphase interactions, is typically applied only to systems below 20 vol % loading, and usually assumes the dispersed phase has spherical geometry (n=⅓). In this scenario, Maxwell's model collapses into the more common Maxwell's equation used in hybrid or composite membrane analysis. From our density measurements, we calculated the bulk density of UiO-66-NH₂ to be 1.53 g/cm³, which is close to the estimated density of 1.3 g/cm³ for a perfect crystal and ideal unit cell. Assuming the experimental density, we find that hybrid membranes contain a maximum of 45 vol % MOF, which is well beyond the 20 vol % threshold for typical applications of Maxwell's model.

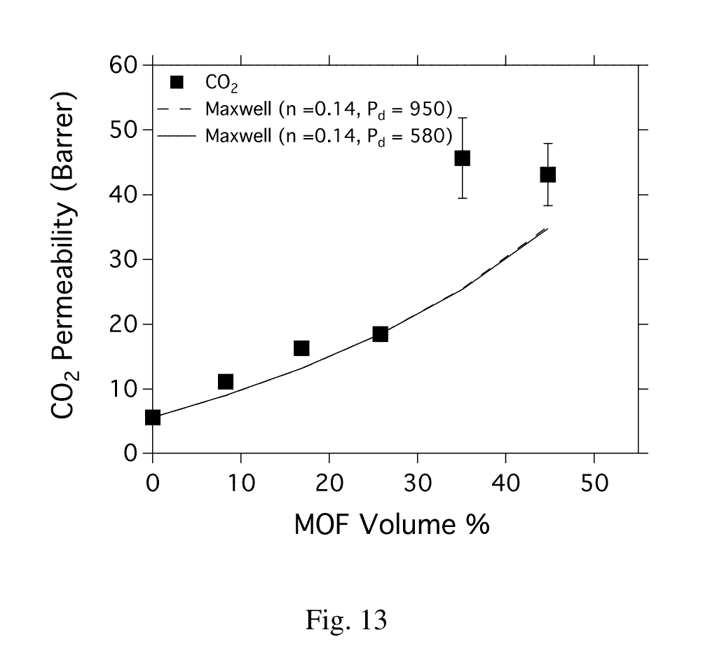

However, we can still apply Maxwell's equation (n=⅓) in hybrid membranes containing below 30 wt % (25 vol %) UiO-66-NH₂ as shown in Fig. S3 of the ESI. The equation severely underestimates permeability values by up to 44%, even when assuming an infinitely permeable dispersed phase. Gas permeability of UiO-66-NH₂ has not been previously measured before, and thus, there is not an accepted literature value to use as P_{d}. We speculate that the poor prediction of Maxwell's model could arise from one of two possibilities. First, poor interactions between the polymer and MOF can result in interphase voids, which act as fast non-selective diffusive pathways. However, our T_{g} measurements and SEM images indicate the opposite, where good interfacial interactions are present. Second, our approximation of spherical geometry of the dispersed phase could be incorrect. This scenario is more likely than the former and is at least suggested by partial aggregation observed in SEM images (FIGS. 2 and 3). Allowing the shape factor, n, to be an adjustable parameter, we find Maxwell's model closely approximates experimental values below 30 wt % when n is equal to 0.14, equivalent to elongated ellipsoid oriented parallel to transport direction, and P_{d} varies between 500 and 1000 barrers, as shown in FIG. 13 of the ESI. However, the model is still not a good predictor above 30 wt %, which would be expected given the model's assumptions and hybrid systems, which oftentimes manifest new properties that cannot be simply modeled using effective medium analysis.

FIG. 6. Pure gas permeabilities of CO₂ (triangles), N₂ (squares), and CH₄ (circles) at 3 bar and 35° C. of hybrid UiO-66-NH₂ polysulfone membranes as a function of weight % of the MOF. There is a dramatic jump in permeability between 30 and 40 wt % due to percolative network of MOF crystals. Error bars represent a single standard deviation.

FIG. 7. Ideal CO₂/N₂ (squares) and CO₂/CH₄ (circles) selectivities obtained from the hybrid UiO-66-NH₂ polysulfone membranes at 3 bar and 35° C. as a function of weight % of the MOF. Selectivity effectively remains constant with addition of UiO-66-NH₂. Error bars represent a single standard deviation.

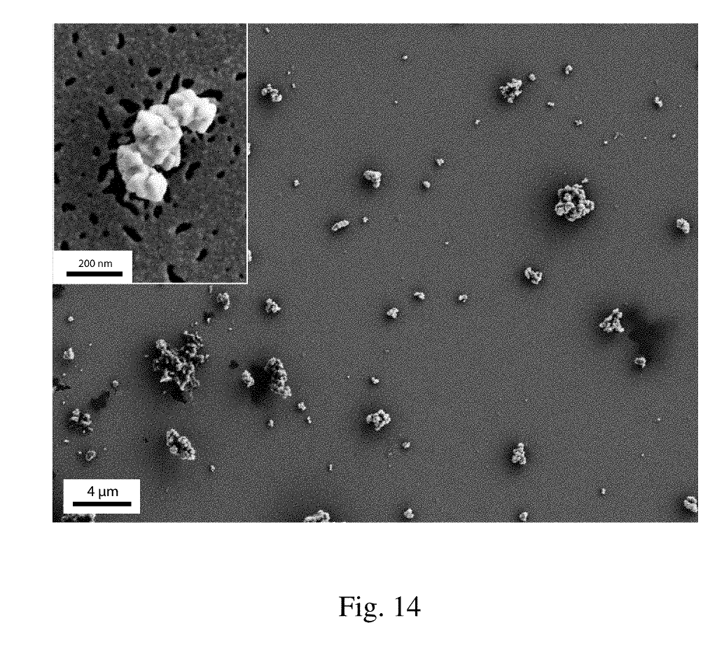

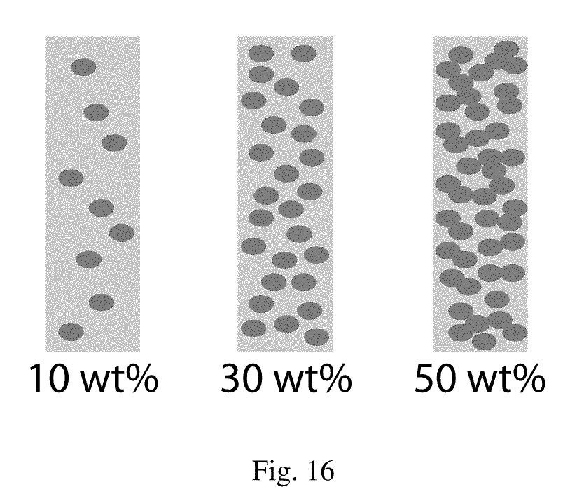

The dramatic increase in permeability in hybrid membranes when loading is increased from 30 to 40 wt % UiO-66-NH₂ is postulated to arise from the formation of a percolative network of MOF crystals throughout the membrane, whose effect is not captured in effective medium models. Percolation is reached when the dispersed phase surpasses a threshold volume fraction, forming an interconnected network, which spans across the entire system. Below this value, no interconnectivity across the entire system is present. The percolation threshold depends on the dimensionality of the system as well as the shape and aspect ratio of the discontinuous phase. A shape factor, n, of 0.14 suggests that the ellipsoids will have an aspect ratio between 2 and 3 and this is suggested by SEM images of MOF nanoparticles (see FIG. 14). Applying the percolation model theorized for ellipsoids by Garboczi et al., percolation is expected to occur between 26 and 31 vol %. This threshold overlaps with volume loading of 30 wt % (25 vol %) and 40 wt % (35 vol %) hybrid membranes, indicating that we are in the percolation regime at 40 and 50 wt %. The cross-section SEM images (FIGS. 2 and 3) show a visible change in morphology wherein regions of interconnected network of MOF crystals appear. This concept is illustrated in FIG. 16 of the ESI when both the polymer and MOF exhibit continuity across the membrane. As a result, molecular transport through the MOF acts as a transport highway exhibiting higher diffusivity over solution-diffusion transport through the polymer. The higher permeation rates through the MOF are due to crystalline microporous structure, which is governed by a transport mechanism closely resembling molecular sieving. The pore size of UiO-66-NH₂ is between 6-7 Å and is larger than the average kinetic diameters of the gas molecules explored (CO₂ (3.3 Å), N₂ (3.64 Å), and CH₄ (3.8 Å)). The pore size to molecular size ratio does not constitute transport by molecular sieving that typically displays much higher selectivity values than polymer systems. However, Knudsen transport is not likely because the mean free path of the largest gas molecule, CH₄, is over two orders of magnitude higher than the pore size; additionally, the observed selectivities are much higher than expected for materials that typically fall within the Knudsen regime.

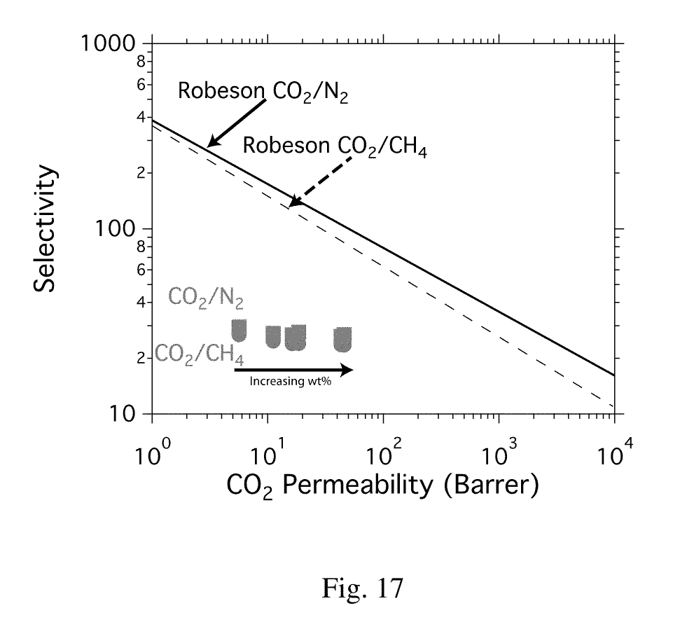

The selectivity of CO₂ over N₂ and CH₄ is shown in FIG. 7. The CO₂/N₂ and CO₂/CH₄ selectivity of pure polysulfone is 30 and 27, respectively, and are similar to those previously reported in literature. As UiO-66-NH₂ is added to reach 10 wt % loading there is an initial decrease in CO₂/N₂ and CO₂/CH₄ selectivity of just 8%. As loading is increased to 50 wt % MOF, the selectivities have only decreased 12% from the polymer only membranes. Coupled with the large increase in permeability, the collective separation performance in these hybrid membranes is greatly enhanced over neat polysulfone and moves closer towards the Robeson upper bound line (FIG. 17 of the ESI). Surprisingly, the stability of CO₂/N₂ and CO₂/CH₄ selectivity and large increase in CO₂ permeability has not been readily seen in the hybrid membrane literature for carbon capture applications as the transport properties are still primarily governed by the solution-diffusion model. A comparison of our results to those in literature is listed in Table 2. We find that our system provides the largest increases in permeability without sacrificing permeability. Reports that do show similar performance improvements are isolated to a few studies involving olefin-paraffin separation processes. Further, the recent work by Smith et al. suggests that metallation of the MOF can lead to enhanced interactions and structural changes in the polymer that can further improve or separation performance and will be important in our future design of hybrid membranes.

TABLE 2
Selected CO₂ permeability % increase and selectivity values
of hybrid membranes reported in literature and this work.

| | | | CO₂ | | | |
|---|---|---|---|---|---|---|
| | | | Perme- | | | |
| | Inorganic | | ability | CO₂/ | CO₂/ | |
| Material | Loading | | Increase | CH₄ | N₂ | Ref. |
| PSF/UiO-66-NH₂ | 50 | wt % | 770% | 24 | 26 | This Work |
| PI/ZIF-8 | 40 | wt % | 155% | 27 | 23 | Ordonez et al. |
| PI/Mg(dodbc) | 10 | wt % | 30% | — | 23 | Bae et al. |
| PIM-1/ | 5 | wt % | 370% | — | 21 | Smith et al. |
| UiO-66-NH₂(Ti) | | | | | | |
| PI/ZIF-8 | 30 | wt % | 255% | 25 | 17 | Song et al. |
| PI/Silica | 30 | wt % | 156% | 238 | 41 | Suzuki et al. |
| PI/CMS | 36 | wt % | 26% | 52 | 33 | Vu et al. |
| PI/CMS | 36 | wt % | 210% | 53 | 33 | Vu et al. |
| PB/MgO | 60 | wt % | 1000% | 4.1 | 7.8 | Matteucci et al. |

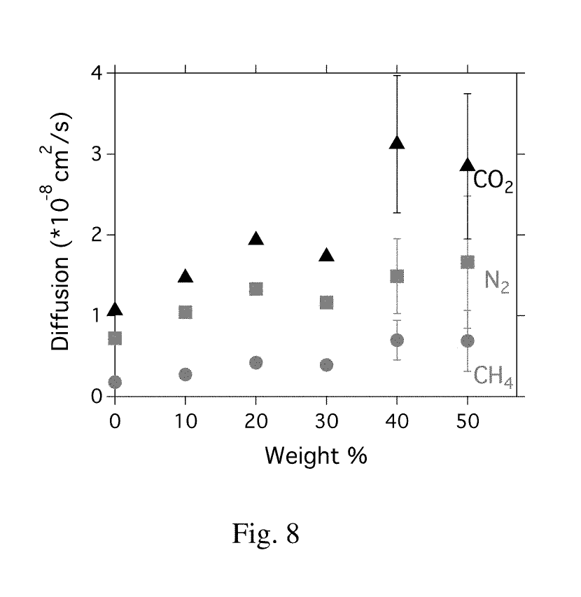

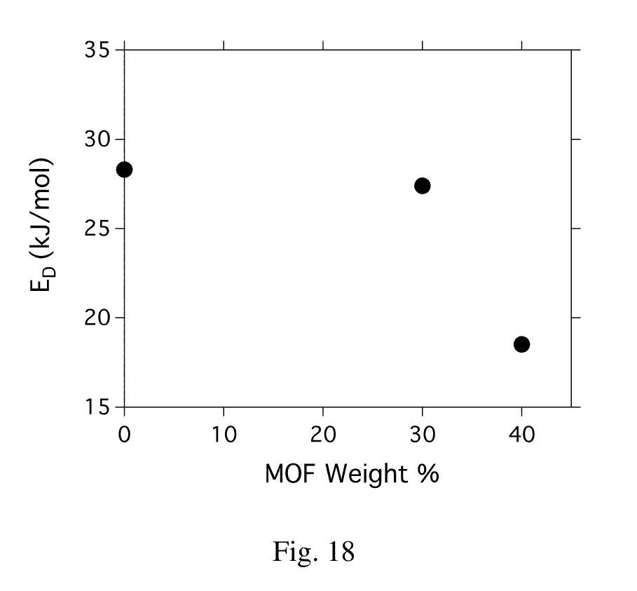

To better understand the changes in the transport mechanism, we investigate diffusivity values for hybrid membranes as a function of weight % as shown in FIG. 8. Diffusion coefficients were estimated by permeation time-lag experiments. As expected, the diffusion coefficient scales inversely with the kinetic diameter of the gas molecule. CO₂ has the highest diffusion coefficient, while CH₄ has the lowest diffusion coefficient. The CO₂ diffusion coefficient gradually rises from 1.1*10⁻⁸ cm²/s to 1.7*10⁻⁸ cm²/s in membranes containing 0 to 30 wt % MOF. Interestingly, after 30 wt %, the diffusion coefficient jumps to above 2.9*10⁻⁸ cm²/s with membranes containing 40 and 50 wt % UiO-66-NH₂; this trend is similarly observed for N₂ and CH₄ as well. Thus, this jump is consistent and what is expected as a parallel transport pathway of interconnected MOF crystals is introduced, because diffusion through rigid porous materials is generally higher than that of amorphous polymers. The activation energy for molecular diffusion through rigid porous media is typically lower, because diffusion is not dependent on random thermal fluctuations as found in polymers. We find that the activation energy for diffusion drops significantly upon exceeding the percolation threshold (see FIG. 18 of the ESI).

FIG. 8. Diffusion coefficients of CO₂ (triangles), N₂ (squares), and CH₄ (circles) at 3 bar and 35° C. as a function of UiO-66-NH₂ loading in hybrid membranes. Diffusion coefficient jumps between 30 and 40 wt % MOF due to the formation of interconnected MOF crystal network.

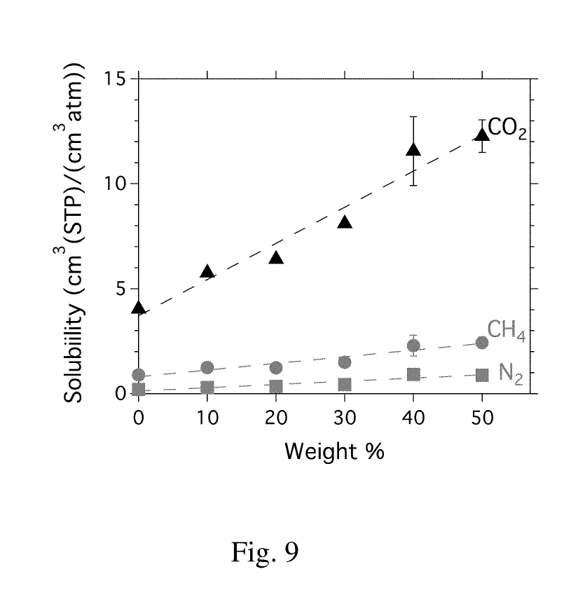

The solution-diffusion model is most commonly used to describe molecular transport through dense polymer membranes From this model, one defines the permeability of a gas through a polymer (P) as the product of both a kinetic term (diffusivity, D) and a thermodynamic term (solubility, S), or simply P=DS. While the model may not be appropriate towards understanding transport mechanisms in hybrid membranes, it can still be a useful tool to provide qualitative solubility trends in hybrid membranes. Using the permeability and diffusivity data collected, we can employ the P=DS relationship to calculate S, which is plotted as a function of weight % in FIG. 9. The overall solubility trend is consistent with observed trends where solubility increases as the critical temperature of gas species increases (T_{c,CO2}>T_{c,CH4},>T_{c,N2}). Unsurprisingly, the solubility exhibits a linear increase as MOF loading increases. For CO₂, the solubility increases from 4 cm³ (STP)/(cm³ atm) in pure polysulfone up to 12 cm³ (STP)/(cm³ atm) in 50 wt % UiO-66-NH₂, representing a 3 fold increase. Solubility is expected to increase in hybrid membranes with the addition of porous and high surface area materials such as UiO-66-NH₂ as they are more tailored for adsorption of molecular species. The solubility of gas in any material system is a thermodynamic value and should not be dependent on any morphological changes in the membrane due to addition of a secondary phase, as was seen with diffusion. As a result, the adsorption capacity of these hybrid membranes depends only on the relative loading of polymer and MOF as was seen similarly in CO₂ adsorption isotherms (FIG. 5).

FIG. 9. Solubility coefficients of CO₂ (triangles), N₂ (squares), and CH₄ (circles) at 3 bar and 35° C. as a function of UiO-66-NH₂ loading in hybrid membranes. Solubility shows a linear relationship with weight %. The dotted lines are linear regression fits of the data.

TABLE 3
CO₂, N₂, and CH₄ permeabilities in barrers
for UiO-66-NH₂ at 3 bar and 35° C.

| MOF Weight % | N₂ | CH₄ | CO₂ |
|---|---|---|---|
| 0% | 0.19 ± 0.011 | 0.21 ± 0.017 | 5.6 ± 0.32 |
| 10% | 0.41 ± 0.012 | 0.45 ± 0.013 | 11 ± 0.32 |
| 20% | 0.61 ± 0.032 | 0.68 ± 0.036 | 16 ± 0.86 |
| 30% | 0.67 ± 0.017 | 0.77 ± 0.02 | 19 ± 0.47 |
| 40% | 1.7 ± 0.024 | 1.9 ± 0.28 | 46 ± 6.2 |
| 50% | 1.65 ± 0.022 | 1.8 ± 0.28 | 43 ± 4.8 |

TABLE 4
CO₂/CH₄ and CO₂/N₂ selectivities
for UiO-66-NH₂ at 3 bar and 35° C.

| MOF Weight % | CO₂/CH₄ | CO₂/N₂ |
|---|---|---|
| 0% | 27 | 30 |
| 10% | 25 | 27 |
| 20% | 24 | 27 |
| 30% | 24 | 28 |
| 40% | 24 | 27 |
| 50% | 24 | 26 |

TABLE 5
Diffusivity, Solubility, and Gas Uptake Values
for UiO-66-NH₂ membranes at 3 bar and 35° C.

| | | | | Solubility | | | | | |
|---|---|---|---|---|---|---|---|---|---|
| | Diffusion * 10\hat{ }8 | | | (cm³ (STP)/ | | | Gas Uptake | | |
| MOF | (cm²/s) | | | (cm³ atm)) | | | (cm³/(cm³ atm)) | | |
| wt % | N₂ | CH₄ | CO₂ | N₂ | CH₄ | CO₂ | N₂ | CH₄ | CO₂ |
| 0% | 0.72 | 0.18 | 1.1 | 0.20 | 0.90 | 4.0 | 0.63 | 2.8 | 12.5 |
| 10% | 1 | 0.27 | 1.5 | 0.30 | 1.2 | 5.8 | 0.92 | 3.9 | 17.9 |
| 20% | 1.3 | 0.42 | 1.9 | 0.35 | 1.2 | 6.4 | 1.1 | 3.8 | 19.8 |
| 30% | 1.2 | 0.39 | 1.7 | 0.44 | 1.5 | 8.1 | 1.4 | 4.7 | 25.5 |
| 40% | 1.5 | 0.7 | 3.1 | 0.92 | 2.3 | 11.6 | 2.8 | 7.2 | 36.0 |
| 50% | 1.7 | 0.69 | 2.9 | 0.88 | 2.4 | 12.3 | 2.7 | 7.6 | 38.2 |

### CONCLUSION

We demonstrate for the first time the formation of dual transport pathways in hybrid polymer/MOF membranes and investigate its evolution as it relates to percolation transition. The formation of dual transport pathways requires high loading of the inorganic phase, which often leads to mechanical failure of the membrane. Using polysulfone and UiO-66-NH₂, we are able to maintain structural integrity of the membranes even at very high loadings (50 wt %). Further, the transport properties associated with dual transport membranes are distinctively different than conventional mixed-matrix membranes, which contain discontinuity with the inorganic phase. Thus, in dual transport membranes, gas transport through the MOF acts as a molecular transport highway and complements classical solution-diffusion through the polymer. Below the percolation threshold, permeation properties of the hybrid membranes are higher than the pure polymer and could easily be fitted to a classical effective medium model. However, above the percolation threshold, permeation properties far exceed what the model could predict and signify a new, non-classical dual transport regime. We find for our hybrid system that dual transport pathways develop between 30 and 40 wt % UiO-66-NH₂. In the percolative regime, CO₂ permeability rises to a remarkable 46 barrers; a 8-fold increase over pure polysulfone. Additional evidence of dual transport pathways is found in a similar phenomenon in CO₂ diffusion as we surpass the percolation threshold. Furthermore, our hybrid membranes deviate from conventional permeability/selectivity trade-off relationships as selectivity over methane and nitrogen remained near that of polysulfone at 22 and 25, respectively. The unique discovery of engineering dual transport pathways enables new approaches towards designing hybrid membranes to significantly improve gas separation performance.

1. A hybrid polymer-inorganic dual transport pathway membrane comprising:
an inorganic phase comprising at least one metal-organic framework (MOF) nanocrystal; and
at least one polymer.

2. The membrane of claim 1, wherein the polymer comprises polysulfone.

3. The membrane of claim 1, wherein the MOF nanocrystal comprises UiO-66-NH₂.

4. The membrane of claim 3, wherein UiO-66-NH₂ comprises Zr₆O₄(OH)₄ octahedral clusters and 2-amino-1,4 benzenedicarboxalate linkers.

5. The membrane of claim 1, wherein an interconnected network of MOF nanocrystals is formed when a percolation threshold is reached.

6. The membrane of claim 5, wherein the percolation threshold is reached when a MOF nanocrystal loading is between 30% weight percent to 50% weight percent.

7. The membrane of claim 1, wherein a MOF nanocrystal loading is between 1% weight percent to 50% weight percent.

8. The membrane of claim 7, wherein the MOF nanocrystal loading is between 10% weight percent to 50% weight percent.

9. The membrane of claim 8, wherein the MOF nanocrystal loading is between 30% weight percent to 50% weight percent.

10. The membrane of claim 9, wherein a CO₂ permeability increases by at least a factor of approximately 8 with increased MOF nanocrystal loading between 30% weight percent to 50% weight percent.

11. The membrane of claim 10, wherein a CO₂ selectivity over methane (CH₄), nitrogen (N₂), increases with increased MOF nanocrystal loading between 30% weight percent to 50% weight percent.

12. The membrane of claim 3 wherein, the MOF nanocrystal comprises a crystalline microporous structure.

13. The membrane of claim 3 wherein, the MOF nanocrystal pore size is approximately between 6 angstroms to 7 angstroms.
